(19) United States
(12) Patent Application Publication
(10) Pub. No.: US 2012/0127629 A1
(43) Pub. Date: May 24, 2012

(54) DOPED ZrO2 CAPACITOR MATERIALS AND STRUCTURES

(75) Inventors: Jeffrey F. Roeder, Brookfield, CT (US); Bryan C. Hendrix, Danbury, CT (US); Steven M. Bilodeau, Oxford, CT (US); Gregory T. Stauf, Branchburg, NJ (US); Tianniu Chen, Rocky Hill, CT (US); Thomas M. Cameron, Newtown, CT (US); Chongying Xu, New Milford, CT (US)

(73) Assignee: ADVANCED TECHNOLOGY MATERIALS, INC., Danbury, CT (US)

(21) Appl. No.: 13/264,745

(22) PCT Filed: Apr. 14, 2010
(86) PCT No.: PCT/US10/31125

§ 371 Date: Jan. 26, 2012

Related U.S. Application Data
(60) Provisional application No. 61/170,071, filed on Apr. 16, 2009.

(51) Int. Cl. H01G 4/10; B32B 19/00; B05D 5/12; B32B 15/04

(52) U.S. Cl. 361/322; 428/641; 428/662; 428/615; 428/665; 428/660; 428/469; 428/472; 428/702; 427/126.3

(57) ABSTRACT

A composite dielectric material including an early transition metal or metal oxide base material and a dopant, co-deposited, alloying or layering secondary material, selected from among Nb, Ge, Ta, La, Y, Ce, Pr, Nd, Gd, Dy, Sr, Ba, Ca, and Mg, and oxides of such metals, and alumina as a dopant or alloying secondary material. Such composite dielectric material can be formed by vapor deposition processes, e.g., ALD, using suitable precursors, to form microelectronic devices such as ferroelectric high k capacitors, gate structures, DRAMs, and the like.

### CROSS-REFERENCE TO RELATED APPLICATION

The benefit of priority of U.S. Provisional Patent Application No. 61/170,071 filed Apr. 16, 2009 in the names of Jeffrey F. Roeder, et al. for “DOPED ZrO₂ CAPACITOR MATERIALS AND STRUCTURES” is hereby claimed under the provisions of 35 USC 119. The disclosure of said U.S. Provisional Patent Application No. 61/170,071 is hereby incorporated herein by reference, in its entirety, for all purposes.

### FIELD

The present invention relates to composite dielectric materials, and to dielectric material structures, such as ferroelectric capacitors, dynamic random access memory devices, and the like, incorporating such composite dielectric materials.

### RELATED ART

The current generation of DRAM capacitors employs ZrO₂ based dielectrics. Challenges exist in managing the electrical leakage of this material and stabilizing its high permittivity form (cubic/tetragonal, c-40) in preference to its low permittivity form (monoclinc, c-20).

An intermediate layer of Al₂O₃ can be used to moderate the electrical leakage of the zirconia-based dielectric. In a parallel plate capacitor, the presence of such an intermediate layer imposes a penalty in overall charge storage. This penalty occurs because the overall capacitance of the device is equal to the inverse sum of the individual capacitances, which in turn are directly related to the dielectric constants of the component layers.

It generally is desirable to achieve higher dielectric constants than 40 in the dielectric material.

### SUMMARY

The present invention relates to composite dielectric materials, and microelectronic devices and device precursor structures comprising such composite dielectric materials.

In one aspect, the invention relates to a composite dielectric material including: (a) an early transition metal or metal oxide base material and (b) a dopant, co-deposited, alloying or layering secondary material, selected from among Nb, Ge, Ta, La, Y, Ce, Pr, Nd, Gd, Dy, Sr, Ba, Ca, and Mg, and oxides of such metals, and alumina as a dopant or alloying secondary material.

In a further aspect, the invention relates to a composite dielectric material including an early transition metal or metal oxide base material and a dopant, co-deposited, alloying or layering secondary material, selected from among Al₂O₃, La₂O₃, SrO, Y₂O₃, MgO, CeO₂, Pr₂O₃, Nd₂O₃ and Dy₂O₃, wherein Al₂O₃, when present, is a dopant or alloying secondary material.

In another aspect, the invention relates to a capacitor structure comprising a composite dielectric material of the invention.

A further aspect of the invention relates to a method of making a dielectric material structure, comprising depositing on a substrate an early transition metal or metal oxide base material, and doping, co-depositing, alloying or layering with said base material a secondary material selected from among Nb, Ge, Ta, La, Y, Ce, Pr, Nd, Gd, Dy, Sr, Ba, Ca, and Mg, and oxides of such metals, and alumina as a dopant or alloying secondary material.

A still further aspect of the invention relates to a method of making a dielectric material structure, comprising depositing on a substrate an early transition metal or metal oxide base material, and doping, co-depositing, alloying or layering with said base material a secondary material selected from among Al₂O₃, La₂O₃, SrO, Y₂O₃, MgO, CeO₂, Pr₂O₃, Nd₂O₃ and Dy₂O₃, wherein Al₂O₃, when present, is a dopant or alloying secondary material.

Yet another aspect of the invention relates to a method of fabricating a microelectronic device, comprising forming a composite dielectric material in accordance with the invention, using a vapor deposition process.

The metals selected from among Al, Nb, Ge, Ta, La, Y, Ce, Pr, Nd, Gd, Dy, Sr, Ba, Ca, and Mg, and oxides of such metals are hereafter referred to as “secondary materials,” while the group of early transition metals and corresponding metal oxides is referred to as “base materials.”

As used herein, the term “layering secondary material” refers to a secondary material layer that is adjacent to and in contact with one or more base material layer(s).

Other aspects, features and embodiments of the invention will be more fully apparent from the ensuing disclosure and appended claims.

### BRIEF DESCRIPTION OF THE DRAWINGS

FIG. 1 is a schematic representation of a composite dielectric capacitor including a composite dielectric material comprising a base material layer 1 and a secondary material layer 2, between top and bottom electrodes.

FIG. 2 is a schematic representation of a composite dielectric capacitor including a composite dielectric material comprising a dielectric base material doped with secondary material.

FIG. 3 is a schematic representation of a composite dielectric capacitor including a composite dielectric material in which a dielectric base material is deposited adjacent to a secondary material.

FIG. 4 is a table of dopant species ion dielectric polarizabilities, in a Periodic Table format.

FIG. 5 is a graph of dielectric polarizabilities of monovalent cations as a function of ionic radius³.

FIG. 6 is a graph of dielectric polarizabilities of divalent cations as a function of ionic radius³.

FIG. 7 is a graph of dielectric polarizabilities of trivalent cations as a function of ionic radius³.

FIG. 8 is a graph of dielectric polarizabilities of tetravalent cations as a function of ionic radius³.

FIG. 9 shows a schematic representation of various film structures 1-4.

### DETAILED DESCRIPTION

The present invention relates to composite dielectric material structures useful for applications such as DRAMS and other microelectronic devices.

In one aspect, the invention relates to a composite dielectric material including an early transition metal or metal oxide base material and a dopant, co-deposited, alloying or layering secondary material.

The present invention contemplates doping a dielectric material to a) control leakage, b) enhance stability of desired phase material, and c) increase dielectric constant, relative to a corresponding dielectric material devoid of the secondary material.

Such doping may be carried out to effect any suitable doping concentration in the dielectric material. In various embodiments, for example, dopant concentration levels can be in a range of from 10¹³ cm⁻³ to 10¹⁸ cm⁻³, or from 10¹⁴ cm⁻³ to 10¹⁷ cm⁻³, or from 10¹⁴ cm⁻³ to 10¹⁶ cm⁻³, or in any other suitable range. In other embodiments, dopant concentration levels of 1 to 5 atomic percent (at. %) are contemplated, and in still other embodiments from 1 to 3 at. %.

The invention includes, in specific embodiments, (i) replacing lower dielectric constant interlayers with higher dielectric constant layers, (ii) replacing lower dielectric constant interlayers with higher dielectric constant layers, and annealing the capacitor material to cause interdiffusion, (iii) doping and/or alloying a dielectric layer, and (iv) manipulating layer thicknesses in the capacitor material.

Base materials for dielectric structures in the broad practice of the invention include zirconium, titanium and other early transition metals, e.g., metals selected from among Ti, Zr, Hf, V, Nb, Ta, Cr, Mo, W, Tc, and Re, and the oxides of such metals. Interlayers, dopants and alloys in structures containing such base materials, wherein the interlayer, dopant or alloy is different from the base material per se, include metals selected from among Nb, Ge, Ta, La, Y, Ce, Pr, Nd, Gd, Dy, Sr, Ba, Ca, and Mg, and oxides of such metals.

Thin film dielectric structures of the invention can be effectively formed by physical vapor deposition (PVD) or other vapor deposition techniques. More advantageously, dielectric films of the invention can be deposited by atomic layer deposition for applications involving high aspect ratio features.

In one aspect, the invention relates to a deposition process, e.g., selected from among CVD and ALD, comprising contacting a substrate with a vapor of a precursor to deposit a film thereon containing zirconium, hafnium, titanium or other early transition metal (as the metal or metalloid species M), using a precursor selected from among compounds of the formulae:

M(NR₂)₄, wherein each R may be the same as or different from the others and each is independently selected from among hydrogen, C₁-C₁₂ alkyl, C₃-C₁₀ cycloalkyl, C₂-C₈ alkenyl (e.g., vinyl, allyl, etc.), C₁-C₁₂ alkylsilyl (including monoalkylsilyl, dialkylsilyl and trialkylsilyl), C₆-C₁₀ aryl, —(CH₂)ₓNR′R″, —(CH₂)ₓOR′″ and —NR′R″, wherein x=1, 2 or 3, and R′, R″ and R′″ may be the same as or different from one another, and each is independently selected from H and C₁-C₁₂ alkyl;

(R¹NC(R³R⁴)ₘNR²)_{(OX-n)/2}MXₙ, wherein R¹, R², R³, R⁴ and X may be the same as or different from one another and each is independently selected from among hydrogen, C₁-C₁₂ alkyl, C₃-C₁₀ cycloalkyl, substituted or unsubstituted cyclopentadienyl, C₂-C₆ alkenyl (e.g., vinyl, allyl, etc.), C₁-C₁₂ alkylsilyl (including monoalkylsilyl, dialkylsilyl, and trialkylsilyl), C₆-C₁₀ aryl, —(CH₂)ₓNR′R″, —(CH₂)ₓOR′″ and —NR′R″, wherein x=1, 2 or 3, and R′, R″ and R′″ can be the same as or different from one another, and each is independently selected from H and C₁-C₁₂ alkyl, wherein the subscripts 1 through 12 in the sequence of carbon numbers designates the number of carbon atoms in the alkyl substituent; m is an integer having a value of from 1 to 6, and in addition, X can be selected from among C₁-C₁₂ alkoxy, carboxylates; beta-diketonates, beta-diketiminates, and beta-diketoiminates, guanidinates, amidinates and isoureates; and further wherein C(R³R⁴)ₘ can be alkylene; OX is the oxidation state of the metal M; n is an integer having a value of from 0 to OX; m is an integer having a value of from 1 to 6;

M(E)₂(OR³)₂ wherein E is substituted dionato, each R³ is the same as or different from the other, and each is independently selected from among C₁-C₁₂ alkyl, C₃-C₁₀ cycloalkyl, C₂-C₈ alkenyl (e.g., vinyl, allyl, etc.), C₁-C₁₂ alkylsilyl (including monoalkylsilyl, dialkylsilyl and trialkylsilyl), C₆-C₁₀ aryl, —(CH₂)ₓNR′R″, —(CH₂)ₓOR′″ and —NR′R″, wherein x=1, 2 or 3, and R′, R″ and R′″ may be the same as or different from one another, and each is independently selected from H and C₁-C₁₂ alkyl, and preferably from among i-propyl and t-butyl (i-propyl being isopropyl and t-butyl being tertiary butyl);

M(OR³)₄ wherein each R³ is the same as or different from the other, and each is independently selected from among C₁-C₁₂ alkyl, C₃-C₁₀ cycloalkyl, C₂-C₈ cycloalkyl, C₂-C₈ alkenyl (e.g., vinyl, allyl, etc.), C₁-C₁₂ alkylsilyl (including monoalkylsilyl, dialkylsilyl and trialkylsilyl), C₆-C₁₀ aryl, —(CH₂)ₓNR′R″, —(CH₂)ₓOR′″ and —NR′R″, wherein x=1, 2 or 3, and R′, R″ and R′″ may be the same as or different from one another, and each is independently selected from H and C₁-C₁₂ alkyl, and preferably from among i-propyl and t-butyl;

M(OPr-i)₄-IPA wherein IPA is isopropyl alcohol and OPr-i is isopropoxy;

(R⁶R⁷1\)₂M(R⁸NC(R³R⁴)ₘNR⁹) wherein R³, R⁴, R⁶ and le , R⁸ and R⁹ may be the same as or different from one another and each is independently selected from among hydrogen, C₁-C₁₂ alkyl, C₃-C₁₀ cycloalkyl, C₂-C₈ alkenyl (e.g., vinyl, allyl, etc.), C₁-C₁₂ alkylsilyl (including monoalkylsilyl, dialkylsilyl and trialkylsilyl), C₆-C₁₀ aryl, —(CH₂)ₓNR′R″, —(CH₂)ₓOR′″ and —NR′R″, wherein x=1, 2 or 3, and R′, R″ and R′″ may be the same as or different from one another, and each is independently selected from H and C₁-C₁₂ alkyl; and m is an integer having a value of from 1 to 6;

compounds selected from among (amidinate)_{OX-n}MXₙ, (guanidinate)_{OX-n}MXₙ and (isoureate)_{OX-n}MXₙ, wherein each X can be the same as or different from the others and each is independently selected from among hydrogen, C₁-C₁₂ alkyl, C₃-C₁₀ cycloalkyl, substituted or unsubstituted cyclopentadienyl, C₂-C₆ alkenyl (e.g., vinyl, allyl, etc.), C₁-C₁₂ alkylsilyl (including monoalkylsilyl, dialkylsilyl, and trialkylsilyl), C₆-C₁₀ aryl, —(CH₂)ₓNR′R″, —(CH₂)ₓOR′″ and —NR′R″, wherein x=1, 2 or 3, and R′, R″ and R′″ can be the same as or different from one another, and each is independently selected from H and C₁-C₁₂ alkyl, wherein the subscripts 1 through 12 in the sequence of carbon numbers designates the number of carbon atoms in the alkyl substituent; m is an integer having a value of from 1 to 6, and in addition, X can be selected from among C₁-C₁₂ alkoxy, carboxylates; beta-diketonates, beta-diketiminates, and beta-diketoiminates, guanidinates, amidinates and isoureates; OX is the oxidation state of the metal M; n is an integer having a value of from 0 to OX; m is an integer having a value of from 1 to 6, and

compounds of the formula RN=M′(NR′R″)₃, wherein R is isopropyl, t-butyl, or t-amyl, and wherein R′ and R″ can be the same as or different from one another, and each is independently selected from C₁-C₄ alkyl;

wherein M is an early transition metal species, e.g., zirconium, hafnium, or titanium, and wherein M′ is tantalum or niobium.

Precursors useful in forming the dielectric materials of the present invention include those described in International Publication WO2008/128141 and those disclosed in International Patent Application PCT/US09/69054, the disclosures of which are hereby incorporated herein by reference.

Zirconium precursors may be employed for forming zirconium-containing dielectric composite materials of the invention, e.g., by chemical vapor deposition and atomic layer deposition, in which each of the ligands coordinated to the zirconium central atom is either an amine or diamine moiety, with at least one of such ligands being diamine. Each of the amine and diamine ligands is substituted or unsubstituted, and when substituted comprises C₁-C₈ alkyl substituents, each of which may be the same as or different from others in the zirconium precursor. Such precursors can be made by a synthesis reaction in which one of the amine groups on a tetrakis amino zirconium molecule is replaced with a diamine moiety. Useful zirconium precursors in various applications include ZrCl₄.

Hafnium precursors useful for forming hafnium-containing films in various embodiments correspondingly include HfCl₄.

Other metal precursors useful in the broad practice of the invention include those of the formulae (A), (B), (C) and (D):

R³ₙM[N(R¹R⁴)(CR⁵R⁶)ₘN(R²)]_{OX-n} (A)

R³ₙM[E(R¹)(CR⁵R⁶)ₘN(R²)]_{OX-n} (B)

R³ₙM[(R²R^{3′}C═CR⁴)(CR⁵R⁶)ₘN(R¹)]_{OX-n} (C)

R³ₙM[E(CR⁵R⁶)ₘN(R¹R²)]_{OX-n} (D)
wherein:
each of R¹, R², R³, R^{3′}, R⁴, R⁵ and R⁶ may be the same as or different from the others, and is independently selected from among H, C₁-C₆ alkyl, C₁-C₆ alkoxy, C₆-C₁₄ aryl, silyl, C₃-C₁₈ alkylsilyl, C₁-C₆ fluoroalkyl, amide, aminoalkyl, alkoxyalkyl, aryloxyalkyl, imidoalkyl, and acetylalkyl;
OX is the oxidation state of the metal M;
n is an integer having a value of from 0 to OX;
m is an integer having a value of from 1 to 6;
M is Ti, Zr or Hf; and
E is O or S.

These precursors have the following formulae:

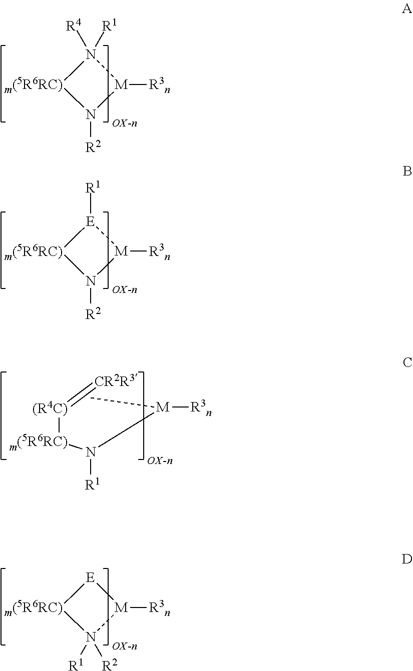

The foregoing precursors of formulae (A)-(D) exhibit good thermal stability and transport properties for CVD/ALD applications.

The aminoalkyl, alkoxyalkyl, aryloxyalkyl, imidoalkyl, and acetylalkyl groups useful as substituents for the precursors (A)-(D) include groups having the following formulae:

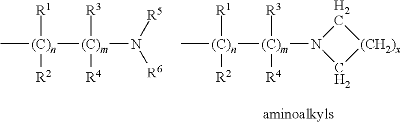

wherein: the methylene (—CH₂—) moiety could alternatively be another divalent hydrocarbyl moiety; each of R₁-R₄ is the same as or different from one another, with each being independently selected from among hydrogen, C₁-C₆ alkyl and C₆-C₁₀ aryl; each of R₅ and R₆ is the same as or different from the other, with each being independently selected from among hydrogen, C₁-C₆ alkyl; n and m are each selected independently as having a value of from 0 to 4, with the proviso that m and n cannot be 0 at the same time, and x is selected from 1 to 5;

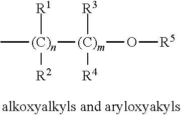

wherein each of R₁-R₄ is the same as or different from one another, with each being independently selected from among hydrogen, C₁-C₆ alkyl, and C₆-C₁₀ aryl; R₅ is selected from among hydrogen, C₁-C₆ alkyl, and C₆-C₁₀ aryl; and n and m are selected independently as having a value of from 0 to 4, with the proviso that m and n cannot be 0 at the same time;

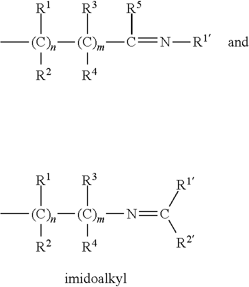

wherein each of R₁, R₂, R₃, R₄, R₅ is the same as or different from one another, with each being independently selected from among hydrogen, C₁-C₆ alkyl, and C₆-C₁₀ aryl; each of R₁′, R₂′ is the same as or different from one another, with each being independently selected from hydrogen, C₁-C₆ alkyl, and C₆-C₁₀ aryl; and n and m are selected independently from 0 to 4, with the proviso that m and n cannot be 0 at the same time;

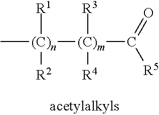

wherein each of R₁-R₄ is the same as or different from one another, with each being independently selected from among hydrogen, C₁-C₆ alkyl, and C₆-C₁₀ aryl; R₅ is selected from among hydrogen, hydroxyl, acetoxy, C₁-C₆ alkyl, C₁-C₁₂ alkylamino, C₆-C₁₀ aryl, and C₁-C₅ alkoxy; and n and m are selected independently from 0 to 4, with the proviso that m and n cannot be 0 at the same time.

Another group of zirconium precursors having utility for forming zirconium-containing films in the practice of the present invention includes the following zirconium precursors, identified as “ZR-1” through “ZR-7.”

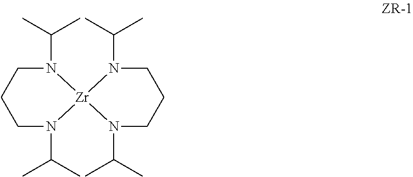

and corresponding compounds wherein the nitrogen atom substituents, rather than being isopropyl, may comprise any suitable organic substituents, including, for example, compounds in which each such nitrogen substituent may be the same as or different from the others and each is independently selected from among hydrogen, C₁-C₁₂ alkyl, C₃-C₁₀ cycloalkyl, C₂-C₈ alkenyl (e.g., vinyl, allyl, etc.), C₁-C₁₂ alkylsilyl (including monoalkylsilyl, dialkylsilyl and trialkylsilyl), C₆-C₁₀ aryl, —(CH₂)ₓNR′R″, —(CH₂)ₓOR′″ and —NR′R″, wherein x=1, 2 or 3, and R′, R″ and R′″ may be the same as or different from one another, and each is independently selected from H and C₁-C₁₂ alkyl;

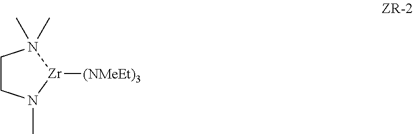

and corresponding compounds wherein the nitrogen atom substituents, rather than being the specified alkyl substituents, may comprise any suitable organic substituents, including, for example, compounds in which each such nitrogen substituent may be the same as or different from the others and each is independently selected from among hydrogen, C₁-C₁₂ alkyl, C₃-C₁₀ cycloalkyl, C₂-C₈ alkenyl (e.g., vinyl, allyl, etc.), C₁-C₁₂ alkylsilyl (including monoalkylsilyl, dialkylsilyl and trialkylsilyl), C₆-C₁₀ aryl, —(CH₂)ₓNR′R″, —(CH₂)ₓOR′″ and —NR′R″, wherein x=1, 2 or 3, and R′, R″ and R′″ may be the same as or different from one another, and each is independently selected from H and C₁-C₁₂ alkyl;

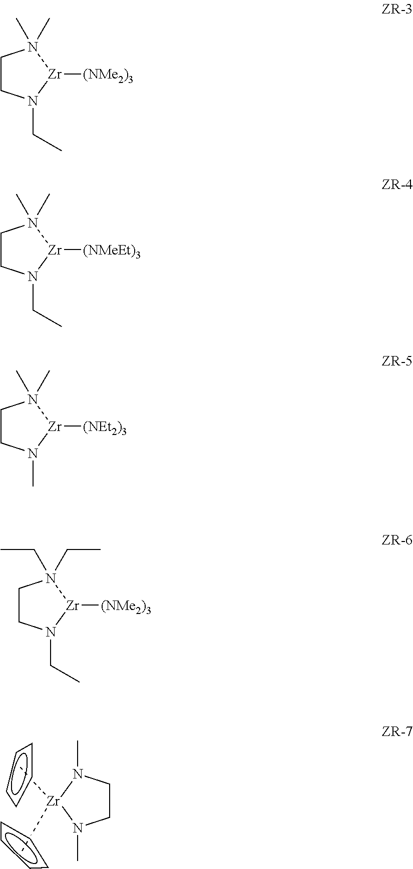

Titanium precursor useful in forming titanium-containing composite dielectric materials in the practice of the invention include precursors selected from the group consisting of TI-1 to TI-5:

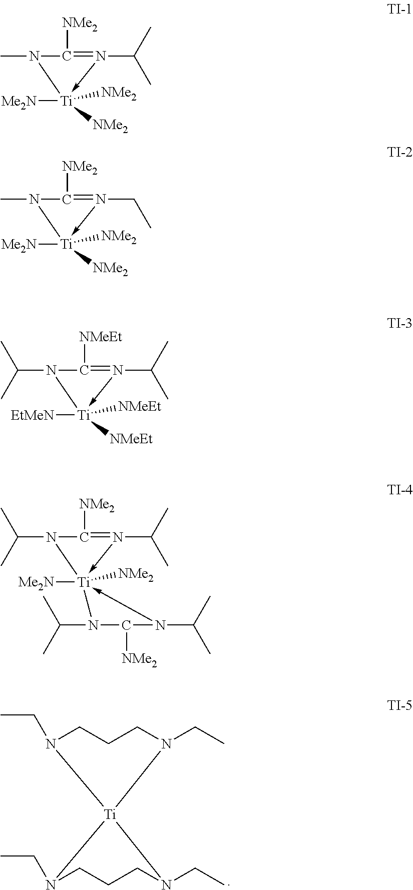

It will be appreciated that a wide variety of different precursors may be employed for forming composite dielectric materials of the invention.

As used herein, the term “film” refers to a layer of deposited material having a thickness below 1000 micrometers, e.g., from such value down to atomic monolayer thickness values. In various embodiments, film thicknesses of deposited material layers in the practice of the invention may for example be below 100, 10, or 1 micrometers, or in various thin film regimes below 200, 100, or 50 nanometers, depending on the specific application involved. As used herein, the term “thin film” means a layer of a material having a thickness below 1 micrometer.

It is noted that as used herein and in the appended claims, the singular forms “a”, “and”, and “the” include plural referents unless the context clearly dictates otherwise.

As used herein, the identification of a carbon number range, e.g., in C₁-C₁₂ alkyl, is intended to include each of the component carbon number moieties within such range, so that each intervening carbon number and any other stated or intervening carbon number value in that stated range, is encompassed, it being further understood that sub-ranges of carbon number within specified carbon number ranges may independently be included in smaller carbon number ranges, within the scope of the invention, and that ranges of carbon numbers specifically excluding a carbon number or numbers are included in the invention, and sub-ranges excluding either or both of carbon number limits of specified ranges are also included in the invention. Accordingly, C₁-C₁₂ alkyl is intended to include methyl, ethyl, propyl, butyl, pentyl, hexyl, heptyl, octyl, nonyl, decyl, undecyl and dodecyl, including straight chain as well as branched groups of such types. It therefore is to be appreciated that identification of a carbon number range, e.g., C₁-C₁₂, as broadly applicable to a substituent moiety, enables, in specific embodiments of the invention, the carbon number range to be further restricted, as a sub-group of moieties having a carbon number range within the broader specification of the substituent moiety. By way of example, the carbon number range e.g., C₁-C₁₂ alkyl, may be more restrictively specified, in particular embodiments of the invention, to encompass sub-ranges such as C₁-C₄ alkyl, C₂-C₈ alkyl, C₂-C₄ alkyl, C₃-C₅ alkyl, or any other sub-range within the broad carbon number range.

The invention in one specific aspect relates to a stacked dielectric structure, in which the base material is an early transition metal or metal oxide, which is doped or deposited with one or more of the metals selected from among Nb, Ge, Ta, La, Y, Ce, Pr, Nd, Gd, Dy, Sr, Ba, Ca, and Mg, and oxides of such metals.

Doping may be carried out within the suitable precursors as source material for the dopant species. For example, when germanium is employed as a doping species, precursors of the formula

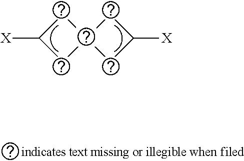

may be used,
wherein:

R′ and R″ may be the same as or different from one another, and are independently selected from among H, C₁-C₆ alkyl, C₅-C₁₀ cycloalkyl, C₆-C₁₀ aryl, and —Si(R³)₃ wherein each R³ is independently selected from C₁-C₆ alkyl; and

each X is independently selected from among C₁-C₆ alkyl, C₁-C₆ alkoxy, —NR′R², and —C(R³)₃, wherein each of R¹, R² and R³ is independently selected from H, C₁-C₆ alkyl, C₅-C₁₀ cyclo alkyl, C₆-C₁₀ aryl, and —Si(R⁴)₃ wherein each R⁴ is independently selected from C₁-C₆ alkyl.

Preferred germanium precursors of such formula include {nBuC(iPrN)₂}₂Ge, also referred to herein as GeM. Germanium precursors such as tetrakis(dimethylamino)germanium can also be employed.

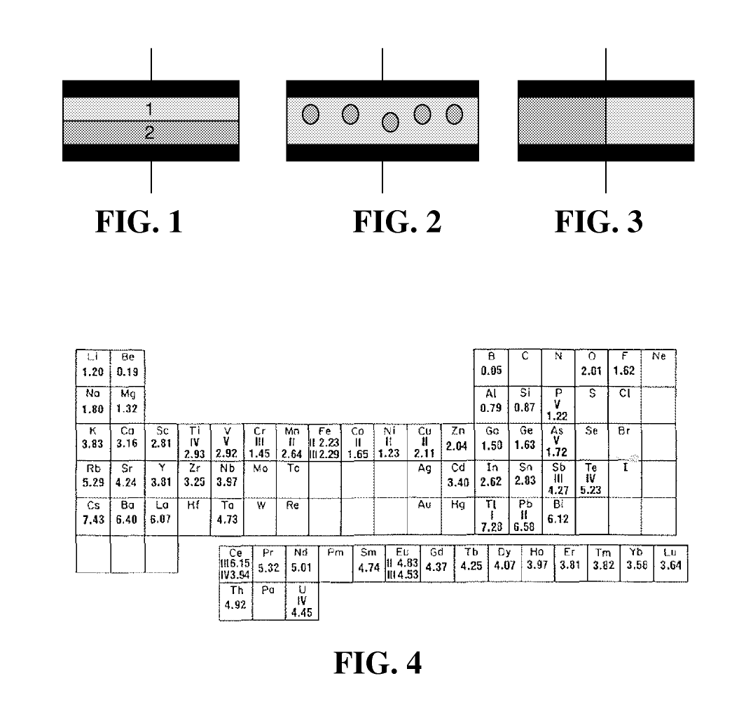

The dielectric capacitor structure in specific embodiments may have a form such as shown in FIGS. 1-3.

As shown in FIG. 1, the capacitor includes a base material layer 1 and a secondary material layer 2. In such capacitor, the capacitance is given by the formula t/Ctotal=t1/C1+t2/C2, wherein t is thickness and C is capacitance.

In the capacitor structure of FIG. 2, the dielectric base material is doped with secondary material.

In the capacitor structure of FIG. 3, the dielectric base material is deposited adjacent to the secondary material. In such capacitor, the capacitance is given by the formula Ctotal =V1C1+V2C2, wherein C is capacitance and V is volume.

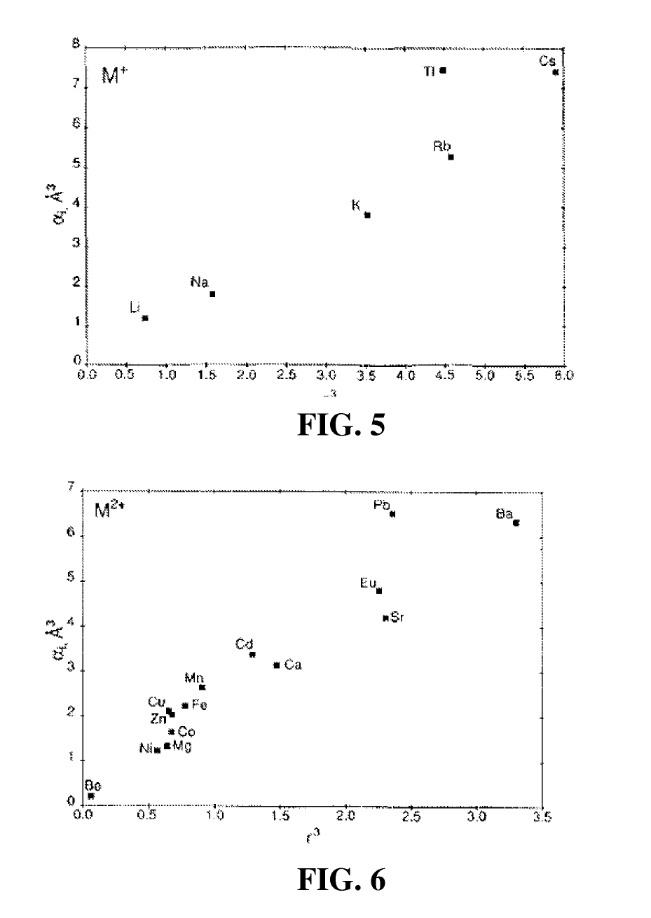

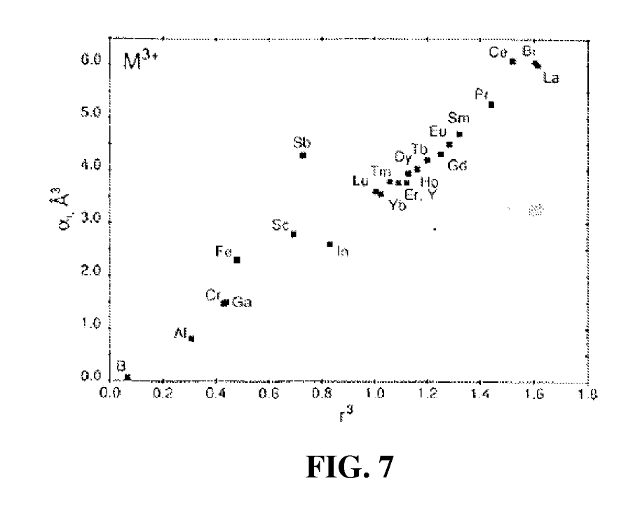

In capacitor structures of the invention, wherein the secondary material is a dopant species, an appropriate dopant species can be selected based on ion dielectric polarizabilities, e.g., using a tabulation of same, such as the Periodic Table tabulation shown in FIG. 4 hereof, wherein the ion dielectric polarizabilities are specified in Å³ units, and the graph of FIG. 5 hereof, showing dielectric polarizabilities of monovalent cations as a function of ionic radius³. FIG. 6 shows a corresponding graph of dielectric polarizabilities of divalent cations as a function of ionic radius³, FIG. 7 shows a corresponding graph of dielectric polarizabilities of trivalent cations as a function of ionic radius³, and FIG. 8 shows a corresponding graph of dielectric polarizabilities of tetravalent cations as a function of ionic radius³.

In one aspect of the invention, the dielectric base material comprises zirconium and titanium, e.g., as zirconium titanate (ZT) or lead zirconium titanate (PZT). Such dielectric film can be formed using precursors such as Zr(OiPr)₂(thd)₂, Ti(OiPr)₂(thd)₂, (C₂H₅)₃PbOCH₂C(CH₃)₃ (TEPOL), tetraethyl lead (TEL), Zr(OtBu)₄, Ti(OiPr)₄, Pb(thd)₂, Zr(thd)₄, or any other suitable metalorganic precursors for the metal constituents of the dielectric film.

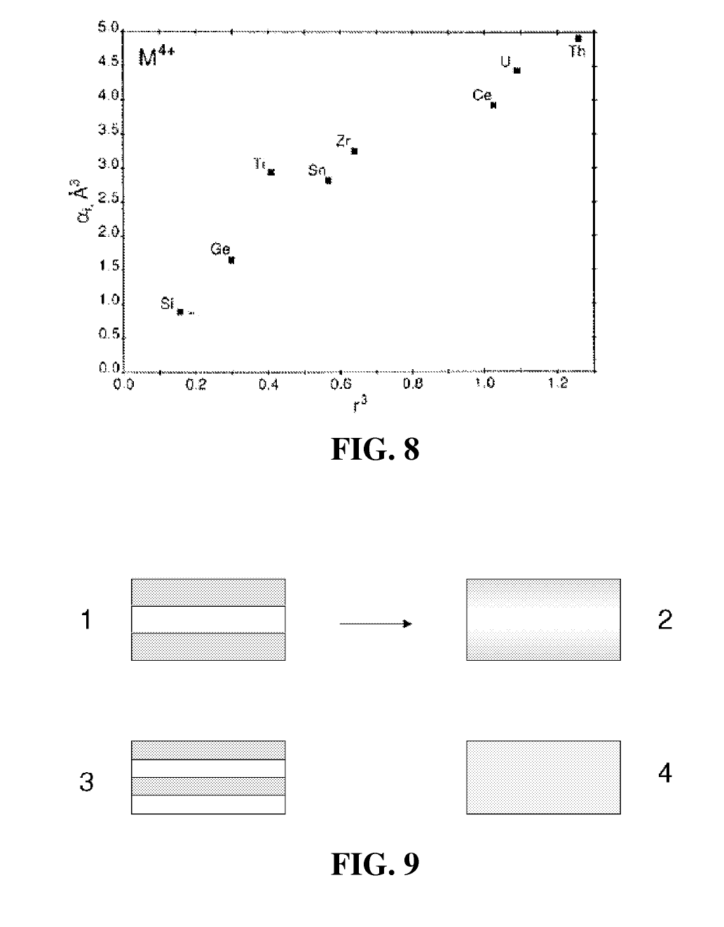

The dielectric capacitor films of the invention may be formed with base materials and secondary materials in a number of ways. For example, FIG. 9 shows a schematic representation of various film structures. Film 1 in FIG. 9 is shown as a multilayer structure of three discrete layers A/B/A wherein A is a base material and B is a secondary material. Film 1 by annealing under conditions that are sufficient to cause interdiffusion of the secondary material B into the base material A layers results in the film 2 shown in FIG. 9. Film 3 in FIG. 9 is a multilayer structure of four discrete layers A/B/A/B wherein A is a base material and B is a secondary material. Film 4 in FIG. 9 is a co-deposited alloy of base material A and secondary material B. The films 1-4 shown in FIG. 9 may be formed with any compatible electrode elements, e.g., comprising a bottom electrode including titanium nitride (TiN) or other suitable material.

In another aspect, capacitor structures of the invention can be formed including a base material A selected from among ZrO₂ and TiO₂, and a secondary material B selected from among Al₂O₃, La₂O₃, SrO, Y₂O₃, MgO, CeO₂(₄), Pr₂O₃, Nd₂O₃ and Dy₂O₃, wherein Al₂O₃, when present, is a dopant or alloying secondary material, and not a co-deposited or layering material. Such base material and secondary material combinations may be employed in films 1-4 of the types shown in FIG. 9.

In such films 1-4, the thicknesses, number of layers and compositions of the films may be varied as appropriate. In film 1, the thickness of the A layers can be independently established, e.g., with a thickness of 2, 4, 6 or 8 nm, and with the thickness of the B layer being 0.1, 0.2, 0.4 or 0.8 nm. Film 2 may have the same initial thicknesses as film 1, prior to annealing thereof. Film 3 may be fabricated with layers A having a thickness of 2 nm, and layers B having a thickness of 0.1 nm. Film 4 may for example have a thickness of 6, 10 or 16 nm, wherein the secondary material has a concentration of 10-90% (e.g., in 10% increments), based on the total volume or thickness of the film.

The composite dielectric material structures of the invention may be part of a DRAM or other microelectronic device.

In one embodiment of the invention, the composite dielectric material structure includes a zirconia-alumina-zirconia (ZAZ) dielectric stack, and is formed by ALD using a TCZR precursor described in the aforementioned International Publication WO2008/128141, wherein the dielectric stack material is doped with a secondary material.

The base material and secondary material composites of the invention may be formed by vapor deposition, such as ALD or CVD, by sputtering, or by other suitable formation method, using appropriate precursor or source reagents, and process conditions, as readily determinable within the skill of the art, based on the disclosure herein.

The invention in a further aspect contemplates co-deposition of precursors to form the composite dielectric material. Such co-deposition can be carried out with two or more than two precursors, each being supplied from a separate source, e.g., a vessel or other reagent supply container, and entering the deposition chamber at the same time, or alternatively with two or more precursors being supplied from the same source container and entering the deposition chamber at the same time, as a mixture of compatible precursor chemistries. The source may for example supply the precursor or precursor mixture in a gaseous or vapor form, or alternatively, the supply precursor or precursor mixture may be supplied in a liquid form and vaporized to form a single component or multicomponent precursor vapor for contacting with the substrate, in the formation of the composite dielectric material.

### INDUSTRIAL APPLICABILITY

The composite dielectric materials of the invention, including an early transition metal or metal oxide base material and a dopant, co-deposited, alloying or layering secondary material, selected from among Nb, Ge, Ta, La, Y, Ce, Pr, Nd, Gd, Dy, Sr, Ba, Ca, and Mg, and oxides of such metals, and alumina as a dopant or alloying secondary material, are readily formed by atomic layer deposition or other vapor deposition processes, and are useful in the manufacture of microelectronic devices such as ferroelectric high k capacitors, gate structures, DRAMs, and the like.

1. A composite dielectric material including: (a) an early transition metal or metal oxide base material; and (b) a dopant, co-deposited, alloying or layering secondary material, selected from among Nb, Ge, Ta, La, Y, Ce, Pr, Nd, Gd, Dy, Sr, Ba, Ca, and Mg, and oxides of such metals, and alumina as a dopant or alloying secondary material.

2. The composite dielectric material of claim 1, wherein the early transition metal is selected from among Ti, Zr, Hf, V, Nb, Ta, Cr, Mo, W, Tc, and Re.

3. The composite dielectric material of claim 1, wherein the base material is doped with the secondary material.

4. The composite dielectric material of claim 1, wherein the base material is co-deposited with the secondary material.

5. The composite dielectric material of claim 1, wherein the base material is alloyed with the secondary material.

6. The composite dielectric material of claim 1, wherein the base material is layered with the secondary material.

7. The composite dielectric material of claim 1, wherein the secondary material is present to an extent that a) controls leakage, b) enhances stability of a phase of the base material, and/or c) increases dielectric constant, relative to a corresponding dielectric material devoid of the secondary material.

8. The composite dielectric material of claim 1, wherein the dielectric base material comprises zirconium titanate.

9. The composite dielectric material of claim 1, including an interlayer comprising a material that is different from the base material and is different from the secondary material.

10. A capacitor structure comprising a composite dielectric material as claimed in claim 1.

11. The capacitor structure of claim 10, wherein the composite dielectric material includes a zirconia-alumina-zirconia (ZAZ) dielectric stack.

12. The capacitor structure of claim 10, wherein the composite dielectric material includes a base material selected from among ZrO₂ and TiO₂.

13. A capacitor structure comprising a composite dielectric material including an early transition metal or metal oxide base material and a dopant, co-deposited, alloying or layering secondary material, selected from among Al₂O₃, La₂O₃, SrO, Y₂O₃, MgO, CeO₂, Pr₂O₃, Nd₂O₃ and Dy₂O₃, wherein Al₂O₃, when present, is a dopant or alloying secondary material.

14. A method of making a dielectric material structure, comprising depositing on a substrate an early transition metal or metal oxide base material, and doping, co-depositing, alloying or layering with said base material a secondary material selected from among Nb, Ge, Ta, La, Y, Ce, Pr, Nd, Gd, Dy, Sr, Ba, Ca, and Mg, and oxides of such metals, and alumina as a dopant or alloying secondary material.

15. The method of claim 14, comprising atomic layer deposition of at least one of the base material and said secondary material.

16. A method of making a dielectric material structure, comprising depositing on a substrate an early transition metal or metal oxide base material, and doping, co-depositing, alloying or layering with said base material a secondary material selected from among Al₂O₃, La₂O₃, SrO, Y₂O₃, MgO, CeO₂, Pr₂O₃, Nd₂O₃ and Dy₂O₃, wherein Al₂O₃, when present, is a dopant or alloying secondary material.

17. The method of claim 14, wherein the early transition metal or metal oxide base material is deposited using a precursor selected from among compounds of the formulae:
M(NR₂)₄, wherein each R may be the same as or different from the others and each is independently selected from among hydrogen, C₁-C₁₂ alkyl, C₃-C₁₀ cycloalkyl, C₂-C₈ alkenyl (e.g., vinyl, allyl, etc.), C₁-C₁₂ alkylsilyl (including monoalkylsilyl, dialkylsilyl and trialkylsilyl), C₆-C₁₀ aryl, —(CH₂)ₓNR′R″, —(CH₂)ₓOR′″ and —NRR″, wherein x=1, 2 or 3, and R′, R″ and R′″ may be the same as or different from one another, and each is independently selected from H and C₁-C₁₂ alkyl;
(R¹NC(R³R⁴)ₘNR²)_{(OX-n)/2}MXₙ, wherein R¹, R², R³, R⁴ and X may be the same as or different from one another and each is independently selected from among hydrogen, C₁-C₁₂ alkyl, C₃-C₁₀ cycloalkyl, substituted or unsubstituted cyclopentadienyl, C₂-C₆ alkenyl (e.g., vinyl, allyl, etc.), C₁-C₁₂ alkylsilyl (including monoalkylsilyl, dialkylsilyl, and trialkylsilyl), C₆-C₁₀ aryl, —(CH₂)ₓNR′R″, —(CH₂)ₓOR′″ and —NR′R″, wherein x=1, 2 or 3, and R′, R″ and R′″ can be the same as or different from one another, and each is independently selected from H and C₁-C₁₂ alkyl, wherein the subscripts 1 through 12 in the sequence of carbon numbers designates the number of carbon atoms in the alkyl substituent; m is an integer having a value of from 1 to 6, and in addition, X can be selected from among C₁-C₁₂ alkoxy, carboxylates; beta-diketonates, beta-diketiminates, and beta-diketoiminates, guanidinates, amidinates and isoureates; and further wherein C(R³R⁴)ₘ can be alkylene; OX is the oxidation state of the metal M; n is an integer having a value of from 0 to OX; m is an integer having a value of from 1 to 6;
M(E)₂(OR³)₂ wherein E is substituted dionato, each R³ is the same as or different from the other, and each is independently selected from among C₁-C₁₂ alkyl, C₃-C₁₀ cycloalkyl, C₂-C₈ alkenyl (e.g., vinyl, allyl, etc.), C₁-C₁₂ alkylsilyl (including monoalkylsilyl, dialkylsilyl and trialkylsilyl), C₆-C₁₀ aryl, —(CH₂)ₓNR′R″, —(CH₂)ₓOR′″ and —NR′R″, wherein x=1, 2 or 3, and R′, R″ and R′″ may be the same as or different from one another, and each is independently selected from H and C₁-C₁₂ alkyl, and preferably from among i-propyl and t-butyl (i-propyl being isopropyl and t-butyl being tertiary butyl);
M(OR³)₄ wherein each R³ is the same as or different from the other, and each is independently selected from among C₁-C₁₂ alkyl, C₃-C₁₀ cycloalkyl, C₂-C₈ alkenyl (e.g., vinyl, allyl, etc.), C₁-C₁₂ alkylsilyl (including monoalkylsilyl, dialkylsilyl and trialkylsilyl), C₆-C₁₀ aryl, —(CH₂)ₓNR′R″, —(CH₂)ₓOR′″ and —NR′R″, wherein x=1, 2 or 3, and R′, R″ and R′″ may be the same as or different from one another, and each is independently selected from H and C₁-C₁₂ alkyl, and preferably from among i-propyl and t-butyl;
M(OPr-i)₄-IPA wherein IPA is isopropyl alcohol and OPr-i is isopropoxy;
(R⁶R⁷N)₂M(R⁸NC(R³R⁴)ₘNR⁹) wherein R³, R⁴, R⁶ and R⁷ , R⁸ and R⁹ may be the same as or different from one another and each is independently selected from among hydrogen, C₁-C₁₂ alkyl, C₃-C₁₀ cycloalkyl, C₂-C₈ alkenyl (e.g., vinyl, allyl, etc.), C₁-C₁₂ alkylsilyl (including monoalkylsilyl, dialkylsilyl and trialkylsilyl), C₆-C₁₀ aryl, —(CH₂)ₓNR′R″, —(CH₂)ₓOR′″ and —NR′R″, wherein x=1, 2 or 3, and R′, R″ and R′″ may be the same as or different from one another, and each is independently selected from H and C₁-C₁₂ alkyl; and m is an integer having a value of from 1 to 6;
compounds selected from among (amidinate)_{OX-n}MXₙ, (guanidinate)_{OX-n}MXₙ and (isoureate)_{OX-n}MXₙ, wherein each X can be the same as or different from the others and each is independently selected from among hydrogen, C₁-C₁₂ alkyl, C₃-C₁₀ cycloalkyl, substituted or unsubstituted cyclopentadienyl, C₂-C₆ alkenyl (e.g., vinyl, allyl, etc.), C₁-C₁₂ alkylsilyl (including monoalkylsilyl, dialkylsilyl, and trialkylsilyl), C₆-C₁₀ aryl, —(CH₂)ₓNR′R″, —(CH₂)ₓOR′″ and —NR′R″, wherein x=1, 2 or 3, and R′, R″ and R′″ can be the same as or different from one another, and each is independently selected from H and C₁-C₁₂ alkyl, wherein the subscripts 1 through 12 in the sequence of carbon numbers designates the number of carbon atoms in the alkyl substituent; m is an integer having a value of from 1 to 6, and in addition, X can be selected from among C₁-C₁₂ alkoxy, carboxylates; beta-diketonates, beta-diketiminates, and beta-diketoiminates, guanidinates, amidinates and isoureates; OX is the oxidation state of the metal M; n is an integer having a value of from 0 to OX; m is an integer having a value of from 1 to 6, and compounds of the formula RN=M′(NR′R″)₃, wherein R is isopropyl, t-butyl, or t-amyl, and wherein R′ and R″ can be the same as or different from one another, and each is independently selected from C₁-C₄ alkyl;
wherein M is an early transition metal species, and M′ is tantalum or niobium.

18. The method of claim 15, wherein the early transition metal or metal oxide base material is deposited using a precursor selected from among compounds of the formulae:
M(NR₂)₄, wherein each R may be the same as or different from the others and each is independently selected from among hydrogen, C₁-C₁₂ alkyl, C₃-C₁₀ cycloalkyl, C₂-C₈ alkenyl (e.g., vinyl, allyl, etc.), C₁-C₁₂ alkylsilyl (including monoalkylsilyl, dialkylsilyl and trialkylsilyl), C₆-C₁₀ aryl, —(CH₂)ₓNR′R″, —(CH₂)ₓOR′″ and —NR′R″, wherein x=1, 2 or 3, and R′, R″ and R′″ may be the same as or different from one another, and each is independently selected from H and C₁-C₁₂ alkyl;
(R¹NC(R³R⁴)ₘNR²)_{(OX-n)/2}MXₙ, wherein R¹, R², R³, R⁴ and X may be the same as or different from one another and each is independently selected from among hydrogen, C₁-C₁₂ alkyl, C₃-C₁₀ cycloalkyl, C₂-C₆ alkenyl (e.g., vinyl, allyl, etc.), C₁-C₁₂ alkylsilyl (including monoalkylsilyl, dialkylsilyl, and trialkylsilyl), C₆-C₁₀ aryl, —(CH₂)ₓNR′R″, —(CH₂)ₓOR′″ and—NR′R″, wherein x=1, 2 or 3, and R′, R″ and R′″ can be the same as or different from one another, and each is independently selected from H and C₁-C₁₂ alkyl, wherein the subscripts 1 through 12 in the sequence of carbon numbers designates the number of carbon atoms in the alkyl substituent; m is an integer having a value of from 1 to 6, and in addition, X can be selected from among C₁-C₁₂ alkoxy, carboxylates; beta-diketonates, beta-diketiminates, and beta-diketoiminates, guanidinates, amidinates and isoureates; and further wherein C(R³R⁴)ₘ can be alkylene; OX is the oxidation state of the metal M; n is an integer having a value of from 0 to OX; m is an integer having a value of from 1 to 6;
M(E)₂(OR³)₂ wherein E is substituted dionato, each R³ is the same as or different from the other, and each is independently selected from among C₁-C₁₂ alkyl, C₃-C₁₀ cycloalkyl, C₂-C₈ alkenyl (e.g., vinyl, allyl, etc.), C₁-C₁₂ alkylsilyl (including monoalkylsilyl, dialkylsilyl and trialkylsilyl), C₆-C₁₀ aryl, —(CH₂)ₓNR′R″, —(CH₂)ₓOR′″ and —NR′R″, wherein x=1, 2 or 3, and R′, R″ and R′″ may be the same as or different from one another, and each is independently selected from H and C₁-C₁₂ alkyl, and preferably from among i-propyl and t-butyl (i-propyl being isopropyl and t-butyl being tertiary butyl);
M(OR³)₄ wherein each R³ is the same as or different from the other, and each is independently selected from among C₁-C₁₂ alkyl, C₃-C₁₀ cycloalkyl, C₂-C₈ alkenyl (e.g., vinyl, allyl, etc.), C₁-C₁₂ alkylsilyl (including monoalkylsilyl, dialkylsilyl and trialkylsilyl), C₆-C₁₀ aryl, —(CH₂)ₓNR′R″, —(CH₂)ₓOR′″ and —NR′R″, wherein x=1, 2 or 3, and R′, R″ and R′″ may be the same as or different from one another, and each is independently selected from H and C₁-C₁₂ alkyl, and preferably from among i-propyl and t-butyl;
M(OPr-i)₄-IPA wherein IPA is isopropyl alcohol and OPr-i is isopropoxy;
(R⁶R⁷N)₂M(R⁸NC(R³R⁴)ₘNR⁹) wherein R³, R⁴, R⁶ and R⁷ , R⁸ and R⁹ may be the same as or different from one another and each is independently selected from among hydrogen, C₁-C₁₂ alkyl, C₃-C₁₀ cycloalkyl, C₂-C₈ alkenyl (e.g., vinyl, allyl, etc.), C₁-C₁₂ alkylsilyl (including monoalkylsilyl, dialkylsilyl and trialkylsilyl), C₆-C₁₀ aryl, —(CH₂)ₓNR′R″, —(CH₂)ₓOR′″ and —NR′R″, wherein x=1, 2 or 3, and R′, R″ and R′″ may be the same as or different from one another, and each is independently selected from H and C₁-C₁₂ alkyl; and m is an integer having a value of from 1 to 6;
compounds selected from among (amidinate)_{OX-n}MXₙ, (guanidinate)_{OX-n}MXₙ and (isoureate)_{OX-n}MXₙ, wherein each X can be the same as or different from the others and each is independently selected from among hydrogen, C₁-C₁₂ alkyl, C₃-C₁₀ cycloalkyl, C₂-C₆ alkenyl (e.g., vinyl, allyl, etc.), C₁-C₁₂ alkylsilyl (including monoalkylsilyl, dialkylsilyl, and trialkylsilyl), C₆-C₁₀ aryl, —(CH₂)ₙNR′R″, —(CH₂)ₓOR′″ and —NR′R″, wherein x=1, 2 or 3, and R′, R″ and R′″ can be the same as or different from one another, and each is independently selected from H and C₁-C₁₂ alkyl, wherein the subscripts 1 through 12 in the sequence of carbon numbers designates the number of carbon atoms in the alkyl substituent; m is an integer having a value of from 1 to 6, and in addition, X can be selected from among C₁-C₁₂ alkoxy, carboxylates; beta-diketonates, beta-diketiminates, and beta-diketoiminates, guanidinates, amidinates and isoureates; OX is the oxidation state of the metal M; n is an integer having a value of from 0 to OX; m is an integer having a value of from 1 to 6, and
compounds of the formula RN=M′(NR′R″)₃, wherein R is isopropyl, t-butyl, or t-amyl, and wherein R′ and R″ can be the same as or different from one another, and each is independently selected from C₁-C₄ alkyl;
wherein M is an early transition metal species, and M′ is tantalum or niobium.

19. The method of claim 14, wherein the dielectric base material comprises zirconium titanate.

20. The method of claim 15, wherein the dielectric base material comprises zirconium titanate.

21. A method of fabricating a microelectronic device, comprising forming a composite dielectric material as claimed in claim 1, using a vapor deposition process.

22. The method of claim 21, wherein the vapor deposition process comprises atomic layer deposition.

23. A composite dielectric material including an early transition metal or metal oxide base material and a dopant, co-deposited, alloying or layering secondary material, selected from among Al₂O₃, La₂O₃, SrO, Y₂O₃, MgO, CeO₂, Pr₂O₃, Nd₂O₃ and Dy₂O₃, wherein Al₂O₃, when present, is a dopant or alloying secondary material.

24. The method of claim 14, wherein the base material comprises zirconium, and said zirconium is deposited by vapor deposition from a cyclopentadienyl zirconium triamide precursor.

25. The method of claim 24, wherein the cyclopentadienyl zirconium triamide precursor comprises CpZr(NMe₂)₃ wherein Cp is cyclopentadienyl and Me is methyl.
